(19) United States
(12) Patent Application Publication
(10) Pub. No.: US 2026/0052502 A1
(43) Pub. Date: Feb. 19, 2026

(54) Systems for RTT Based Sidelink Positioning

(71) Applicant: Apple Inc., Cupertino, CA (US)

(72) Inventors: Oghenekome Oteri, San Diego, CA (US); Dawei Zhang, Saratoga, CA (US); Wei Zeng, Saratoga, CA (US); Hong He, San Jose, CA (US); Sigen Ye, San Diego, CA (US); Huaning Niu, San Jose, CA (US); Haitong Sun, Saratoga, CA (US); Chunxuan Ye, San Diego, CA (US); Seyed Ali Akbar Fakoorian, San Diego, CA (US); Chunhai Yao, Beijing (CN); Weidong Yang, San Diego, CA (US); Ankit Bhamri, Haar (DE)

(21) Appl. No.: 19/101,158

(22) PCT Filed: Aug. 12, 2022
(86) PCT No.: PCT/CN2022/112118

§ 371 Date: Feb. 4, 2025

(51) Int. Cl. H04W 64/00; H04L 47/283; H04W 72/25

(52) U.S. Cl. CPC H04W 64/00; H04L 47/283; H04W 72/25

(57) ABSTRACT

Apparatuses, systems, and methods for RTT based sidelink positioning, e.g., in 5G NR systems and beyond. A UE may transmit an indication of sidelink positioning capabilities. The indication may include a round trip time (RTT) measurement capability and/or a positioning reference signal (PRS) capability. The UE may determine a supporting UE for a sidelink positioning procedure, e.g., based, at least in part, sidelink positioning capabilities of the supporting UE. Additionally, the UE may request a start of the sidelink positioning procedure to one of the supporting UE, a location management function (LMF), or sidelink LMF.

### FIELD

The invention relates to wireless communications, and more particularly to apparatuses, systems, and methods for round trip time (RTT) sidelink positioning, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for RTT based sidelink positioning, e.g., in 5GNR systems and beyond.

For example, in some embodiments, a UE may be configured to transmit an indication of sidelink positioning capabilities. The indication may include a round trip time (RTT) measurement capability and/or a positioning reference signal (PRS) capability. The UE may be configured to determine a supporting UE for a sidelink positioning procedure, e.g., based, at least in part, sidelink positioning capabilities of the supporting UE. Additionally, the UE may be configured to request a start of the sidelink positioning procedure to one of the supporting UE, a location management function (LMF), or sidelink LMF.

As another example, in some embodiments, a UE may be configured to determine resources for at least one RTT transmission as part of a sidelink positioning procedure. The UE may be configured to acquire the resources and perform the sidelink positioning procedure using the acquired resources.

As a further example, in some embodiments, a UE may be configured to schedule a multi-RTT PRS sequence exchange with two or more supporting UEs using sidelink control information (SCI). The SCI may be the same as an SCI for a physical sidelink shared channel (PSSCH) or a dedicated SCI for RTT PRS sequence transmission. In addition, the UE may be configured to perform one of a serial or parallel PRS sequence exchange with the two or more supporting UEs.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIG. 6 illustrates an example of signaling between sidelink devices for a double sided RTT, according to some embodiments.

FIGS. 7A and 7B illustrate examples of information that may be exchanged between a UE and a network entity, according to some embodiments.

FIGS. 8A and 8B illustrate examples of information that may be exchanged between network entities, according to some embodiments.

FIGS. 9A and 9B illustrate further examples of information that may be exchanged between network entities, according to some embodiments.

FIGS. 10A and 10B illustrate additional examples of information that may be exchanged between network entities, according to some embodiments.

FIG. 11 illustrates a block diagram of an example of a method for capability exchange for a sidelink positioning procedure, according to some embodiments.

FIG. 12 illustrates a block diagram of an example of a method for resource allocation for a sidelink positioning procedure, according to some embodiments.

FIG. 13 illustrates a block diagram of an example of a method for multi-round trip time (RTT) estimation as part of a sidelink positioning procedure, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel
PDSCH: Physical Downlink Shared Channel
RRC: Radio Resource Control

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is served by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

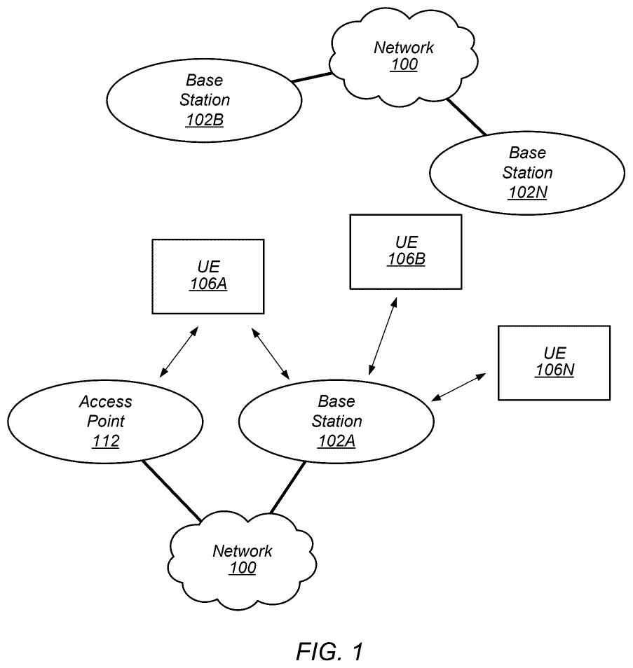

### FIG. 1: Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5GNR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

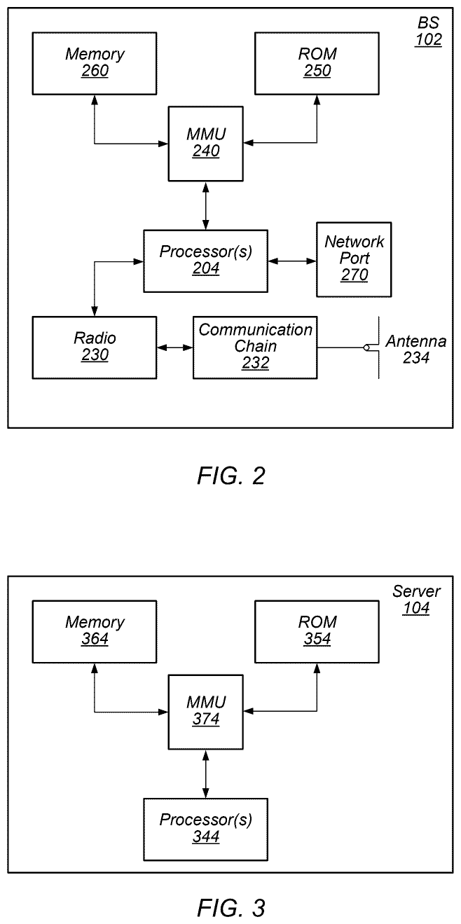

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices served by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5GNR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

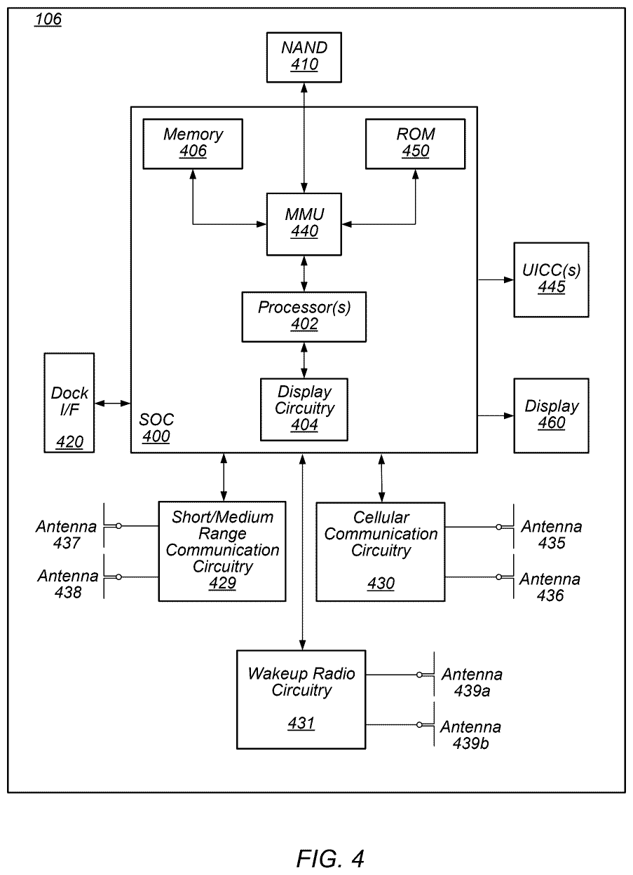

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431 may also couple (e.g., communicatively; directly or indirectly) to one or more antennas, such as antennas 439a and 439b as shown. Alternatively, the wakeup radio circuitry 431 may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for revocation and/or modification of user consent in MEC, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 kHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

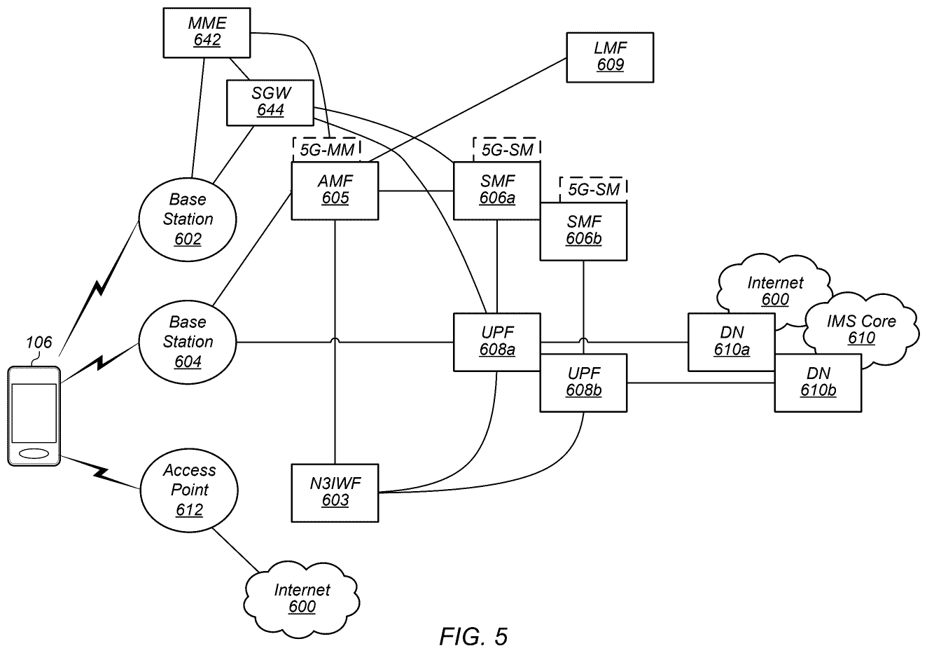

FIG. 5: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, each of which may be a base station 102) and an access point, such as AP 612. The AP 612 may include a connection to the Internet 600 as well as a connection to a non-3GPP interworking function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described network entities may be configured to perform methods for RTT based sidelink positioning, e.g., in 5GNR systems and beyond, e.g., as further described herein.

### RTT Based Sidelink Positioning

In current implementations, methods for sidelink positioning in cellular systems, e.g., such as NR cellular systems have not been defined and/or agreed upon. However, it has been agreed upon to study sidelink positioning measurement methods based on RTT-type solutions, angle of arrival (AoA) based solutions (including both Azimuth of arrival and Zenith of arrival), time-different of arrival (TDOA) based solutions, and angle of departure (AoD) based solutions (including both Azimuth of departure and Zenith of departure). Further, it has been agreed upon that studies should include aspects such as definition(s) of corresponding sidelink measurements for each method, which methods may be applicable to absolute or relative positioning or ranging, antenna configuration consideration(s) using practical UE capabilities, per-panel location, e.g., if a UE uses multiple panels, a UE's mobility, especially for V2X scenarios, impact of synchronization error(s) between UEs, and whether existing sidelink measurements (e.g. such as reference signal receive power (RSRP) and/or received signal strength indicator (RSSI)) and UE identity (ID) information may be used.

In some implementations, round trip time (RTT) based positioning may remove a requirement of tight network timing synchronization across nodes (e.g., as needed in legacy techniques such as TDOA) and may offer additional flexibility in network deployment and maintenance. In addition, multi-RTT positioning method may make use of a UE's receive-transmit (Rx-Tx) time difference measurements and downlink positioning reference signal (PRS) RSRP (PRS-RSRP) of downlink signals received from multiple transmit-receive points (TRPs) measured by the UE and measured base station gNB Rx-Tx time difference measurements and uplink sounding reference signal (SRS) RSRP (SRS-RSRP) at multiple TRPs of uplink signals transmitted from UE to derive a location/position of the UE. For example, in current 5G NR systems, for multi-RTT, a location management function (LMF) of the network may initiate a procedure whereby multiple TRPs and a UE perform the base station Rx-TX and UE Rx-Tx measurements, respectively. For multi-RTT, the base stations may transmit downlink PRSs and the UE may transmit uplink SRSs. The base station configures the uplink SRS to the UE using a radio resource control (RRC) protocol and the LMF provides the downlink PRS configuration using an LTE positioning protocol (LPP). The UE then reports measurement results using LPP to the LMF and the base stations report measurement results using NR positioning protocol A (NRPPa) to the LMF. The LMF then estimates the location of the UE.

Embodiments described herein provide systems, methods, and mechanisms for RTT based sidelink positioning, including systems, methods, mechanisms for RTT based sidelink procedure initialization, including UE capability exchange, supporting device selection, and information exchange, resource allocation for sidelink Mode 1 and sidelink Mode 2, transmission and measurement of sidelink reference signals (RSs) for sidelink RTT, and feedback and time of flight estimation, including single sided RTT feedback and measurements, as well as definition of measurement and assistance information that may be exchanged between a UE and a network entity as well as between network entities.

For example, in some instances, an initiating device (e.g., initiator) and one or more supporting devices may indicate sidelink positioning capabilities to one another. Note that the one or more supporting devices may be sidelink devices such as other UEs, roadside units (RSUs), and/or positioning reference units (PRUs)) and/or a mix of sidelink devices and network entities and/or devices (e.g., such as base stations and/or multiple transmit-receive points (TRPs). In some instances, there may be a mutual exchange of sidelink positioning capabilities between the initiating device and the one or more supporting devices. In some instances, there may be an indirect exchange of sidelink positioning capabilities between the initiating device and the one or more supporting devices, e.g., via support of a location management function (LMF), e.g., for in-coverage and/or partial coverage scenarios, or via support of a sidelink LMF (SL-LMF), e.g., for out-of-coverage scenarios. Note that an SL-LMF may be a sidelink entity acting as an LMF in a sidelink positioning operation. For example, the SL-LMF may be part of a target UE (e.g., the UE whose location is being determined), part of a supporting device, and/or part of another sidelink device (e.g., a device not involved in the sidelink positioning operation). In some instances, sidelink positioning capabilities may include (e.g., in addition and/or in the alternative to any other sidelink positioning capability) an indication of support of single sided RTT, double sided RTT, or both single sided RTT and double sided RTT. In some instances, sidelink positioning capabilities may include (e.g., in addition and/or in the alternative to any other sidelink positioning capability) an indication of positioning reference signal (PRS) capability, e.g., such as support for standalone PRS slots, support for multiplexed PRS slots (e.g., multiplexed with a physical sidelink shared channel (PSSCH), support for Zadoff Chu based PRSs, support for Gold sequence based PRSs, and/or any combination thereof.

In some instances, a UE may select one or more supporting devices for an RTT or a multi-RTT operation. For example, the UE may select one or more supporting devices for a multi-RTT operation (e.g., for absolute positioning in multi-RTT positioning) based on indicated supporting device capability (e.g., an RSU may indicate that it broadcasts its actual position), path loss, and/or other signal quality metrics. In some instances, an LMF and/or an SL-LMF may indicate, to the UE, the one or more supporting devices.

In some instances, an initiating (or requesting) UE (e.g., a requestor UE) may request a start of a sidelink positioning procedure by requesting sidelink positioning procedure information. In some instances, the initiating UE may be a target UE and may request sidelink positioning procedure information from one or more supporting devices. In some instances, the initiating UE may be a target UE and may request sidelink positioning procedure information from an LMF or an SL-LMF. In some instances, the initiating UE may be a supporting UE and may request sidelink positioning procedure information from a target UE. In some instances, the initiating UE may be a supporting UE and may request sidelink positioning procedure information from an LMF or an SL-LMF.

In some instances, for sidelink Mode 1 operation, a network entity (e.g., a base station or LMF) or an SL-LMF may allocate resources for sidelink reference signal (RS) (e.g., such as sidelink positioning reference signals (PRSs) and/or sidelink sounding reference signals (SRSs)) transmission. Further, the network entity or the SL-LMF may indicate the allocated resources to a target UE as well as supporting devices.

In some instances, for sidelink Mode 2 operation, a UE may autonomously select resources for RTT transmissions (e.g., for sidelink RS transmissions). Note that, for a single sided RTT, resources may be selected for a first transmission and a second transmission and for a double sided RTT, resources may be selected for a first transmission, a second transmission, and a third transmission. In some instances, each device in a sidelink positioning procedure may independently acquire their own resources. In some instances, one device in a sidelink positioning procedure may acquire resources for all devices. In some instances, resources may be semi-statically configured through high-layer signaling (e.g., such as radio resource control (RRC) signaling, LTE positioning protocol (LPP) signaling, sidelink positioning protocol (SLPP) signaling, and/or PC5-RRC signaling) as periodic or semi-persistent transmissions. In some instances, devices may activate and receive acknowledgment of resource allocations, e.g., for on-demand sidelink RSs. In some instances, devices may receive a configuration of devices e.g., for always-on sidelink RSs. In some instances, each device in a sidelink positioning procedure may randomly select resources (the resources may be within a certain range from a location request and/or devices may be configured with resource sets and randomly select resources from the resource set, e.g., a first device randomly selects resources form the resource set and communicates the selected resources to a second device).

For example, for a single sided RTT, a first device (e.g., a UE, such as UE 106) may acquire resources for a first transmission and communicate the resources to a second device (e.g., a supporting device which may be another UE 106 and/or a base station 102). The second device may then acquire resources for a second transmission. Then, the first device may transmit the first transmission (e.g., a first sidelink RS) followed by the second device transmitting the second transmission.

As another example, for a single sided RTT, a first device (e.g., a UE, such as UE 106) may acquire resources for a first transmission and a second transmission and may communicate the resources to a second device (e.g., a supporting device which may be another UE 106 and/or a base station 102). Then, the first device may transmit the first transmission (e.g., a first sidelink RS) followed by the second device transmitting the second transmission. In some instances, the second device may be configured (e.g., either semi-statically or dynamically) to use a specific resource relative to the first transmission for the second transmission.

As a further example, for single sided RTT, a first device (e.g., a UE, such as UE 106) may acquire resources for a first transmission and then transmit the first transmission. Then, after a second device (e.g., a supporting device which may be another UE 106 and/or a base station 102) receives the first transmission, the second device may acquire resources for a second transmission and then transmit the second transmission.

As a yet further example, for a double sided RTT, a first device (e.g., a UE, such as UE 106) may acquire resources for a first transmission and a third transmission and communicate the resources to a second device (e.g., a supporting device which may be another UE 106 and/or a base station 102). The second device may then acquire resources for a second transmission, e.g., within a time span of the first and third transmission. Upon successful acquisition of resources, the second device may transmit an acknowledgement to the first device. Further, upon receipt of the acknowledgment, the first device may transmit the first transmission, the second device, after receipt of the first transmission, may transmit the second transmission, and the first device, after receipt of the second transmission, may transmit the third transmission. In some instances, if the second device fails to acquire resources for the second transmission, the second device may transmit a negative acknowledgement (NACK) to the first device and, upon receipt of the NACK, the first device may abort the double sided RTT. In some instances, if the second device fails to acquire resources for the second transmission, the first device may still transmit the first transmission and then determine failure based on not receiving the second transmission from the second device.

As an additional example, a first device (e.g., a UE, such as UE 106) may acquire resources for a first transmission, a second transmission, and a third transmission and communicate the resources to a second device (e.g., a supporting device which may be another UE 106 and/or a base station 102). Ten, the first device may transmit the first transmission, the second device, after receipt of the first transmission, may transmit the second transmission, and the first device, after receipt of the second transmission, may transmit the third transmission. In some instances, the second device may be configured (e.g., either semi-statically or dynamically) to use a specific resource relative to the first transmission and third transmission for the second transmission.

As a further additional example, for a double sided RTT, a first device (e.g., a UE, such as UE 106) may acquire resources for a first transmission and communicate the resources to a second device (e.g., a supporting device which may be another UE 106 and/or a base station 102). The second device may then acquire resources for a second transmission and communicate the resources to the first device. Then, the first device may acquire resources for a third transmission. Upon completion of the acquisition of resources for the third transmission, the first device may transmit the first transmission, the second device, after receipt of the first transmission, may transmit the second transmission, and the first device, after receipt of the second transmission, may transmit the third transmission.

As a yet further additional example, for a double sided RTT, a first device (e.g., a UE, such as UE 106) may acquire resources for a first transmission and communicate the resources to a second device (e.g., a supporting device which may be another UE 106 and/or a base station 102). The second device may then acquire resources for a second transmission and a third transmission communicate the resources to the first device. Then, the first device may transmit the first transmission, the second device, after receipt of the first transmission, may transmit the second transmission, and the first device, after receipt of the second transmission, may transmit the third transmission. In some instances, the second device may be configured (e.g., either semi-statically or dynamically) to use a specific resource relative to the first transmission for the second transmission and the third transmission.

As a final example, for a double sided RTT, a first device (e.g., a UE, such as UE 106) may acquire resources for a first transmission and then transmit the first transmission. Then, after a second device (e.g., a supporting device which may be another UE 106 and/or a base station 102) receives the first transmission, the second device may acquire resources for a second transmission and then transmit the second transmission. Further, upon receipt of the second transmission, the first device may transmit the third transmission.

In some instances, transmission of a sidelink RS (e.g., a PRS and/or an SRS) may use an SCI used for a PSSCH or a dedicated SCI for sidelink RS transmissions.

In some instances, a multi-RTT procedure may be performed serially or in parallel. For example, assume that a target UE (e.g., device A), which may be a UE 106), performs a multi-RTT with one or more supporting devices, e.g., devices B, C, and D. Then, for a serial single sided RTT, a transmission schedule may include signaling as follows:
(1) device A transmits a first sidelink RS to device B;
(2) device A receives a second sidelink RS from device B;
(3) device A transmits a third sidelink RS to device C;
(4) device A receives a fourth sidelink RS from device C;
(5) device A transmits a fifth sidelink RS to device D; and
(6) device A receives a sixth sidelink RS from device D.
   Further, for a parallel single sided RTT, a transmission schedule may include signaling as follows:
(1) device A transmits a first sidelink RS to device B;
(2) device A transmits a second sidelink RS to device C;
(3) device A transmits a third sidelink RS to device D;
(4) device A receives a fourth sidelink RS from device B;
(5) device A receives a fifth sidelink RS from device C; and
(6) device A receives a sixth sidelink RS from device D.
   In addition, for a serial double sided RTT, a transmission schedule may include signaling as follows:
(1) device A transmits a first sidelink RS to device B;
(2) device A receives a second sidelink RS from device B;
(3) device A transmits a third sidelink RS to device B;
(4) device A transmits a fourth sidelink RS to device C;
(5) device A receives a fifth sidelink RS from device C;
(6) device A transmits a sixth sidelink RS to device C;
(7) device A transmits a seventh sidelink RS to device D;
(8) device A receives an eight sidelink RS from device D; and
(9) device A transmits a ninth sidelink RS to device D.
   Further, for a parallel double sided RTT, a transmission schedule may include signaling as follows:
(1) device A transmits a first sidelink RS to device B;
(2) device A transmits a second sidelink RS to device C;
(3) device A transmits a third sidelink RS to device D;
(4) device A receives a fourth sidelink RS from device B;
(5) device A receives a fifth sidelink RS from device C;
(6) device A receives a sixth sidelink RS from device D;
(7) device A transmits a seventh sidelink RS to device B;
(8) device A transmits an eight sidelink RS to device C; and
(9) device A transmits a ninth sidelink RS to device D.

In some instances, for a single sided RTT, a time of flight (e.g., Tf1 and Tf2) for each transmission may be feedback for the RTT procedure and the RTT may be defined as the sum of the time of flights. In some instances, for a double sided RTT, feedback for the RTT procedure may be based on a method of RTT estimation. For example, feedback may include a time of flight (e.g., Tf1, Tf2, and Tf3) for each transmission when the RTT is estimated as shown in either equation [1] or equation [2].

$$RTT = \frac{1}{2} ( Tf 1 + Tf 3 ) + Tf 2 \qquad [ 1 ]$$

$$RTT = \frac{2}{3} ( Tf 1 + Tf 2 + Tf 3 ) \qquad [ 2 ]$$

As another example, feedback may include time stamps that allow estimation of a delay between transmission of the first transmission and reception of the second transmission (e.g., Rₐ), a delay between receipt of the first transmission and transmission of the second transmission (e.g., D_{b}), a delay between receipt of the second transmission and transmission of the third transmission (e.g., Dₐ), and a delay between transmission of the second transmission and receipt of third transmission (e.g., R_{b}) when the time of flight is estimated as shown in either equation [3] or equation [4].

$${T}_{f} = \frac{1}{4} ( {R}_{a} - {D}_{b} + {R}_{b} - {D}_{a} ) \qquad [ 3 ]$$

$${T}_{f} = \frac{{R}_{a} {R}_{b} - {D}_{a} {D}_{b}}{{R}_{a} + {D}_{a} + {R}_{b} + {D}_{b}} \qquad [ 4 ]$$

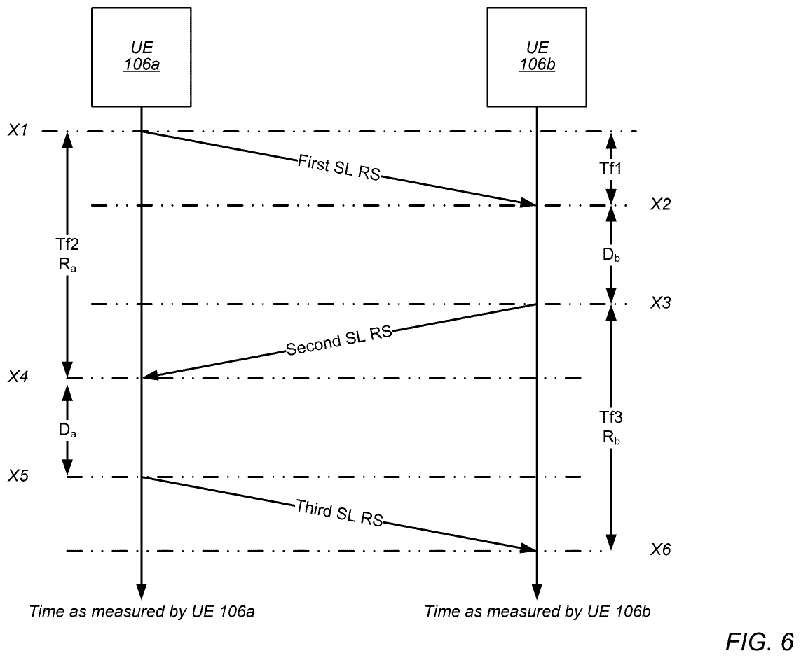

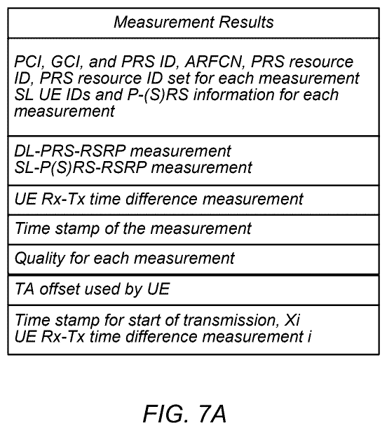

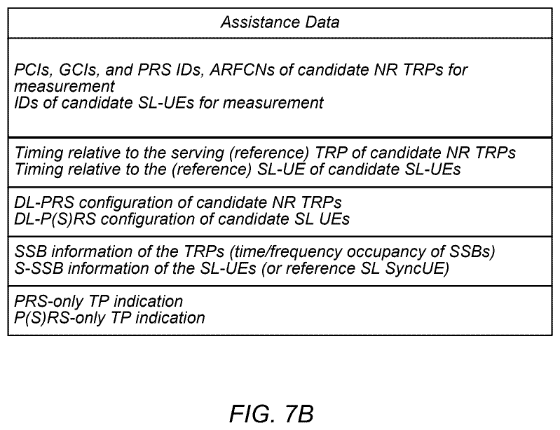

FIG. 6 illustrates an example double sided signaling, according to some embodiments. As shown, at time X1 (wherein X1 is a timestamp of departure/arrival of a sidelink RS), a first device (e.g., UE 106a) may transmit a first sidelink RS transmission to a second device (e.g., UE 106b). The second device may receive the first sidelink RS transmission at time X2. Further, at time X3, the second device may transmit a second sidelink RS to the first device. The first device may receive the second sidelink RS at time X4. Additionally, at time X5, the first device may transmit a third sidelink RS to the second device. The second device may receive the third sidelink RS at time X6. Thus, when using equations [1] or [2], feedback to an LMF or SL-LMF may include Tf1 (e.g., X2−X1), Tf2 (e.g., X4−X3), and Tf4 (e.g., X6−X5). Further, when using equations [3] and [4], feedback may depend upon an entity estimating the time of flight. For example, if the entity is an LMF or SL-LMF, feedback may include X1, Tf1, X3, Tf2, X5, and Tf3 and/or X2, Tf1, X4, Tf2, X6, and TB. As another example, if the entity is the first device, the feedback may include Tf1 and TB since X1, X4, Tf2, and X5 may be known to the first device and X3 can be derived from the known information and the feedback. As a further example, if the entity is the second device, the feedback may include Tf2 since Tf1, X2, X3, Tf2, and X6 are known to the second device and X1, X4, and X5 can be derived. Note that a precision of a time stamp (e.g., X1) may be based on a UE capability and/or on a required positioning accuracy. Note further, that, in some instances, to minimize an error in an RTT estimation based on clock differences between devices, an interval between a first transmission (Tx1) and a second transmission (Tx2) may be equal to an interval between the second transmission and a third transmission (Tx3). Note that if and/or when equation [3] is used for time of flight estimation, then the interval between the first transmission (Tx1) and the second transmission (Tx2) must be equal to the interval between the second transmission and the third transmission (Tx3). In some instances, measurement and assistance information may be shared between sidelink devices (e.g., such as UE 106) and network entities (e.g., such as an LMF, an SL-LMF, or a base station, such as base station 102). For example, as illustrated by FIG. 7A, measurement results, such as physical cell ID (PCI), group cell ID (GCI), PRS identity (ID), absolute radio-frequency channel number (ARFCN), PRS resource ID, PRS resource ID set for each measurement, SL UE IDs, sidelink PRS and/or SRS information for each measurement, sidelink PRS and/or SRS RSRP measurements, one or more UE Rx-Tx time difference measurements, a time stamp (X1) for a start of one or more sidelink RS transmissions, a UE Rx-Tx time difference for a measurement, i, a quality for each measurement, and/or a timing advance (TA) offset used by the UE may be transferred from a UE to an LMF (or SL-LMF). As another example, as illustrated by FIG. 7B, assistance data, such as PCIs, GCIs, and PRS IDs, ARFCNs of candidate NR TRPs for measurement, IDs of candidate SL-UEs for measurement, timing relative to the serving (reference) TRP of candidate NR TRPs, timing relative to the (reference) SL-UE of candidate SL-UEs, DL-PRS configuration of candidate NR TRPs, DL-PRS/SRS configuration of candidate SL UEs, SSB information of the TRPs (time/frequency occupancy of SSBs), S-SSB information of the SL-UEs (or reference SL SyncUE), PRS-only TP indication, and PRS/SRS-only TP indication, may be transferred from an LMF (or SL-LMF) to a UE.

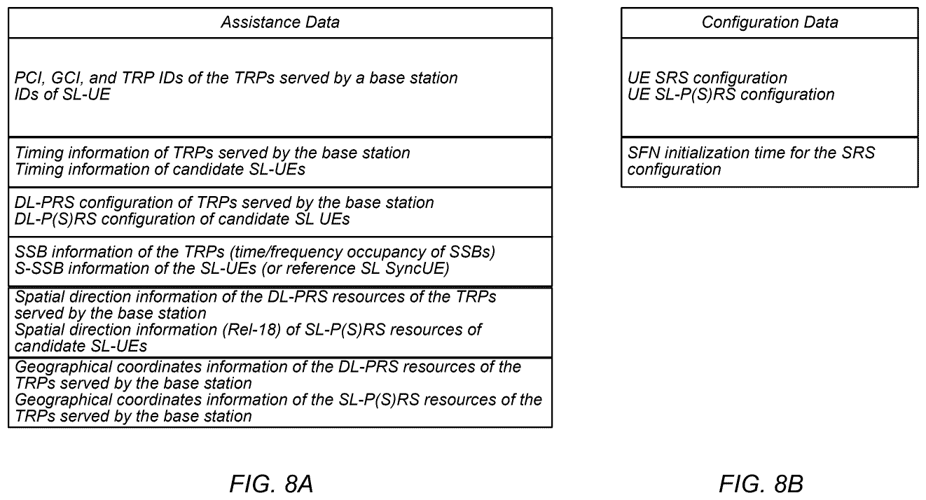

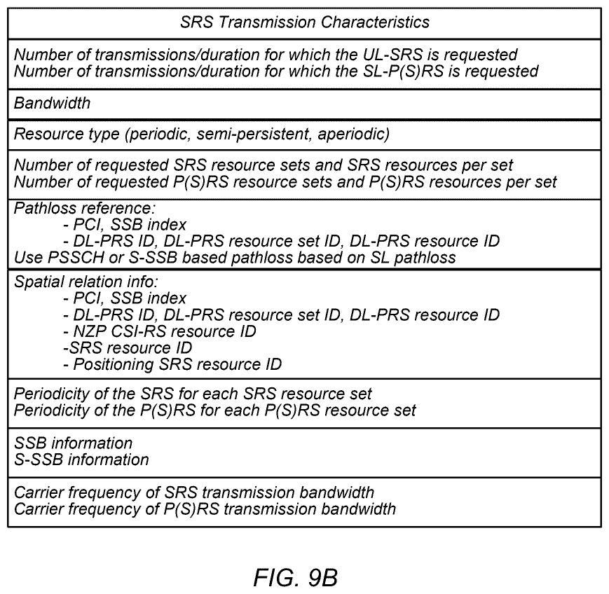

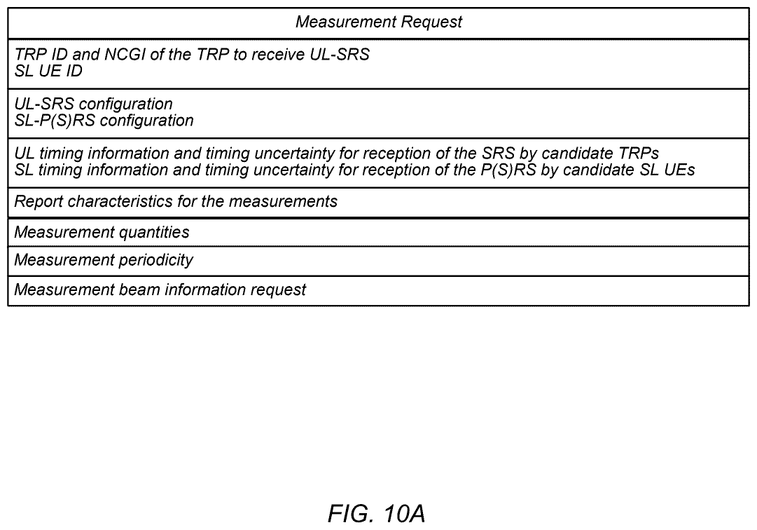

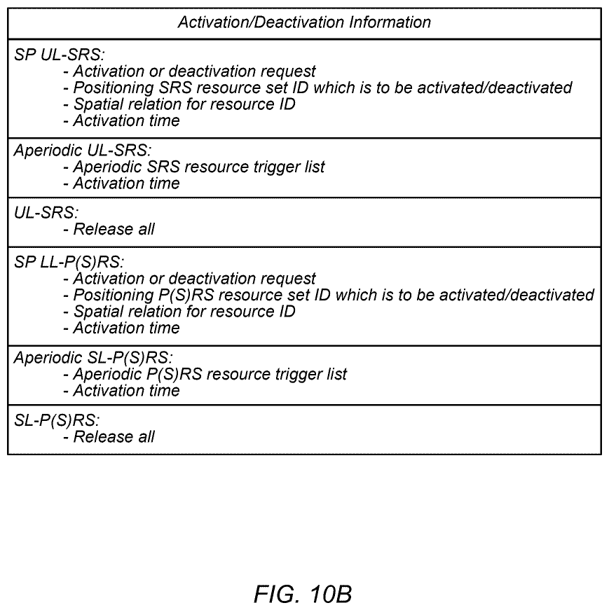

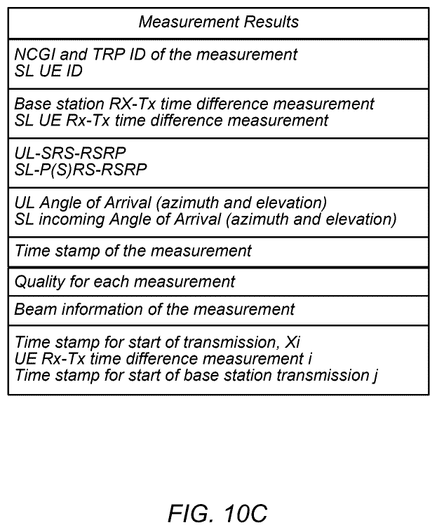

In some instances, measurement and assistance information may be shared between network entities, e.g., such as an LMF (or SL-LMF) and a base station, such as base station 102. For example, as illustrated by FIG. 8A, assistance data, such as PCI, GCI, and TRP IDs of the TRPs served by a base station, IDs of SL-UE, timing information of TRPs served by the base station, timing information of candidate SL-UEs, DL-PRS of configuration TRPs served by the base station, DL-PRS/SRS configuration of candidate SL UEs, SSB information of the TRPs (time/frequency occupancy of SSBs), S-SSB information of the SL-UEs (or reference SL SyncUE), spatial direction information of the DL-PRS resources of the TRPs served by the base station, spatial direction information (Rel-18) of SL-PRS/SRS resources of candidate SL-UEs, geographical coordinates information of the DL-PRS resources of the TRPs served by the base station, and/or geographical coordinates information of the SL-PSR/SRS resources of the TRPs served by the base station, may be transferred from a base station to an LMF (or SL-LMF). As another example, as illustrated by FIG. 8B, uplink information and UE configuration data, such as UE SRS configuration, UE SL-PRS/SRS configuration, and/or start/sequence frame number (SFN) initialization time for the SRS configuration may be transferred from a serving base station of a UE, such as UE 106, to an LMF (or SL-LMF). As a further example, as illustrated by FIG. 9A, measurement results such as NCGI and TRP ID of the measurement, SL UE ID, base station RX-Tx time difference measurement, SL UE Rx-Tx time difference measurement, UL-SRS-RSRP, SL-PRS-RSRP and/or SLSRS-RSRP, UL Angle of Arrival (azimuth and elevation), SL incoming Angle of Arrival (azimuth and elevation), time stamp of the measurement, quality for each measurement, beam information of the measurement, time stamp for start of transmission, X1, UE Rx-Tx time difference measurement i, and/or time stamp for start of base station transmission j, may be transferred from a may be transferred from a base station to an LMF (or SL-LMF). As an additional example, as illustrated by FIG. 9B, uplink SRS transmission characteristics, such as a number of transmissions/duration for which the UL-SRS is requested, a number of transmissions/duration for which the SL-PRS/SRS is requested, bandwidth, a resource type (periodic, semi-persistent, aperiodic), a number of requested SRS resource sets and SRS resources per set, a number of requested PRS/SRS resource sets and PRS/SRS resources per set, a pathloss reference including a PCI, an SSB index, a DL-PRS ID, a DL-PRS resource set ID, a DL-PRS resource ID (note use PSSCH or S-SSB based pathloss based on SL pathloss), spatial relation information including a PCI, an SSB index, a DL-PRS ID, a DL-PRS resource set ID, a DL-PRS resource ID, an NZP CSI-RS resource ID, and an SRS resource ID and a positioning SRS resource ID, periodicity of the SRS for each SRS resource set, periodicity of the P(S)RS for each P(S)RS resource set, SSB information, S-SSB information, a carrier frequency of SRS transmission bandwidth, and/or a carrier frequency of P(S)RS transmission bandwidth, may be transferred from an LMF (or SL-LMF) to a base station. As a further example, as illustrated by FIG. 10A, TRP measurement request information, such as a TRP ID and NCGI of the TRP to receive UL-SRS, a SL UE ID, an UL-SRS configuration, a SL-PRS/SRS configuration, UL timing information and timing uncertainty for reception of the SRS by candidate TRPs, SL timing information and timing uncertainty for reception of the P(S)RS by candidate SL UEs, report characteristics for the measurements, measurement quantities, measurement periodicity, and/or a measurement beam information request, may be transferred from an LMF (or SL-LMF) to a base station. As an additional example, as illustrated by FIG. 10B, requested positioning activation/deactivation information, such as, for an SP UL-SRS, activation or deactivation request, positioning SRS resource set ID which is to be activated/deactivated, a spatial relation for resource ID, and an activation time, for an aperiodic UL-SRS, an aperiodic SRS resource trigger list, an activation time, for UL-SRS, a release all indicator, for an SP SL-PRS/SRS, activation or deactivation request, positioning SRS resource set ID which is to be activated/deactivated, a spatial relation for resource ID, and an activation time, for an aperiodic SL-PRS/SRS, an aperiodic SRS resource trigger list, an activation time, for SL-PRS/SRS, and/or a release all indicator, may be transferred from an LMF (or SL-LMF) to a base station.

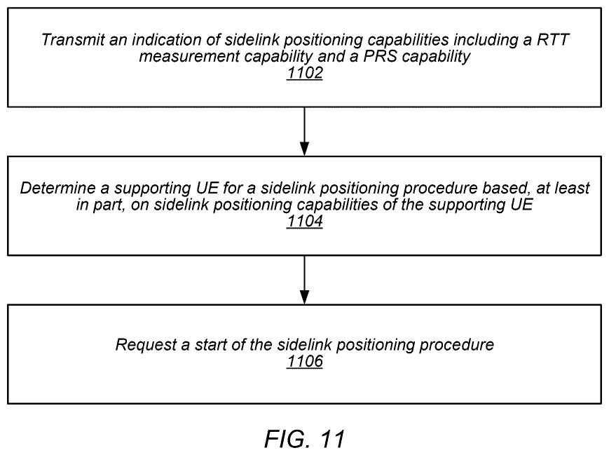

FIG. 11 illustrates a block diagram of an example of a method for capability exchange for a sidelink positioning procedure, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a UE, such as UE 106, may transmit an indication of sidelink positioning capabilities. The indication may include a round trip time (RTT) measurement capability and/or a positioning reference signal (PRS) capability. The RTT measurement capability may indicate whether the UE supports one or both of single sided RTT or double sided RTT. In some instances, when the UE supports double sided RTT, the indication of sidelink positioning capabilities may further include a feedback capability. The feedback capability may indicate one of explicit feedback or implicit feedback. The PRS capability may indicate support for one or more of a standalone PRS slot, PRS slots multiplexed with physical sidelink shared channel (PSSCH) slots, a Zadoff Chu sequenced based PRS, and/or a Gold sequenced based PRS. In some instances, the indication of sidelink positioning capabilities may be transmitted to a supporting UE. In such instances, the UE may receive, from the supporting UE, an indication of the supporting UE's sidelink positioning capabilities. In some instances, the indication of sidelink positioning capabilities may be transmitted to a location management function (LMF), e.g., such as LMF 609. In such instances, the UE may receive, from the LMF, an indication of the supporting UE's sidelink positioning capabilities. In some instances, the indication of sidelink positioning capabilities may be transmitted to a SL-LMF. In such instances, the UE may receive, from the SL-LMF, an indication of the supporting UE's sidelink positioning capabilities.

At 1104, the UE may determine a supporting UE for a sidelink positioning procedure, e.g., based, at least in part, sidelink positioning capabilities of the supporting UE. In some instances, to determine the supporting UE for the sidelink positioning procedure, the UE may select the supporting UE for absolute positioning in a multi-RTT positioning procedure. In some instances, to determine the supporting UE for the sidelink positioning procedure, the UE may select the supporting UE for an-RTT positioning procedure. In some instances, to determine the supporting UE for the sidelink positioning procedure, the UE may receive an indication from one of an LMF or SL-LFM indicating the supporting UE the sidelink positioning procedure.

At 1106, the UE may request a start of the sidelink positioning procedure. In some instances, to request the start of the sidelink positioning procedure, the UE may transmit the request to the supporting UE. In some instances, to request the start of the sidelink positioning procedure, the UE may transmit the request to one of an LMF or SL-LMF.

In some instances, the UE may receive, from one of an LMF or SL-LMF, assistance data. The assistance data may include any of primary cell identities (IDs) (PCIs), group cell IDs (GCIs), and PRS IDs, absolute radio-frequency channel numbers (ARFCNs) of candidate NR transmit-receive points (TRPs) for measurement, IDs of candidate SL-UEs for measurement, timing relative to the serving (reference) TRP of candidate NR TRPs, timing relative to the (reference) SL-UE of candidate SL-UEs, a downlink PRS configuration of candidate NR TRPs, a downlink PRS/SRS configuration of candidate SL UEs, SSB information of the TRPs (time/frequency occupancy of SSBs), S-SSB information of the SL-UEs (or reference SL SyncUE), a PRS-only TP indication, and/or a PRS/SRS-only TP indication. In some instances, the LMF or sidelink LMF may receive the assistance data from a base station serving the UE. In such instances, the assistance data received from the base station may include any of a PCI, a GCI, TRP IDs of the TRPs served by a base station, IDs of SL-UE, timing information of TRPs served by the base station, timing information of candidate SL-UEs, DL-PRS of configuration TRPs served by the base station, DL-PRS/SRS configuration of candidate SL UEs, SSB information of the TRPs (time/frequency occupancy of SSBs), S-SSB information of the SL-UEs (or reference SL SyncUE), spatial direction information of the DL-PRS resources of the TRPs served by the base station, spatial direction information (Rel-18) of SL-PRS/SRS resources of candidate SL-UEs, geographical coordinates information of the DL-PRS resources of the TRPs served by the base station, and/or geographical coordinates information of the SL-PSR/SRS resources of the TRPs served by the base station.

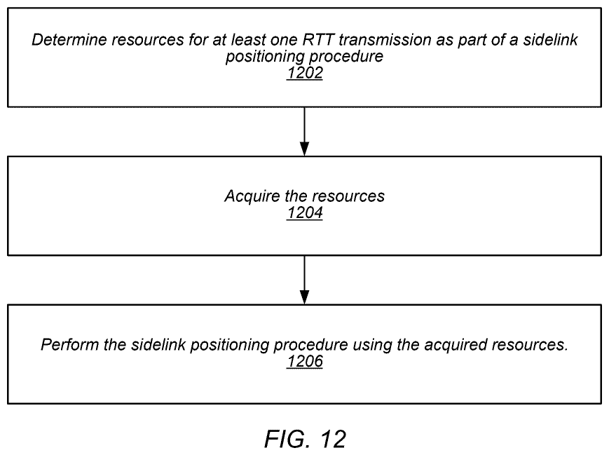

FIG. 12 illustrates a block diagram of an example of a method for resource allocation for a sidelink positioning procedure, according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a UE, such as UE 106, may determine resources for at least one round trip time (RTT) transmission as part of a sidelink positioning procedure.

At 1204, the UE may acquire the resources.

At 1206, the UE may perform the sidelink positioning procedure using the acquired resources.

In some instances, to perform the sidelink positioning procedure, the UE may communicate the acquired resources to a supporting UE. In some instances, e.g., when the sidelink positioning procedure comprises a single sided RTT procedure, the UE may acquire resources for one PRS sequence transmission. Additionally, the UE may transmit, to the supporting UE, a first PRS sequence using the acquired resources and receive, from the supporting UE, a second PRS sequence using resources acquired by the supporting UE. In some instances, e.g., when the sidelink positioning procedure comprises a double sided RTT procedure, the UE may acquire resources for two PRS sequence transmissions. Additionally, the UE may receive, from the supporting UE, an acknowledgment indicating that the supporting UE has acquired resources for a PRS sequence transmission and transmit, to the supporting UE, a first PRS sequence using the acquired resources. Further, the UE may receive, from the supporting UE, a second PRS sequence using resources acquired by the supporting UE and transmit, to the supporting UE, a third PRS sequence using the acquired resources. In some instances, e.g., when the sidelink positioning procedure comprises a double sided RTT procedure, the UE may acquire resources for two PRS sequence transmissions. In addition, the UE may receive, from the supporting UE, a negative acknowledgment indicating that the supporting UE has not acquired resources for a PRS sequence transmission and transmit, to the supporting UE, a first PRS sequence using the acquired resources. In addition, the UE may determine, based on non-receipt of a second PRS sequence from the supporting UE, that an error has occurred during the sidelink positioning procedure.

In some instances, to perform the sidelink positioning procedure, the UE may transmit, to the supporting UE, a first PRS sequence using the acquired resource and receive, from the supporting UE, a second PRS sequence using resources acquired by the supporting UE.

In some instances, e.g., when the sidelink positioning procedure comprises a double sided RTT procedure, to acquire the resources, the UE may acquire resources for a first PRS transmission. In addition, the UE may communicate, to the supporting UE, the resources for the first PRS transmission and receive, from the supporting UE, an indication of resources acquired by the supporting UE for a second PRS transmission. Further, the UE may acquire resources for a third PRS sequence transmission. In some instances, the UE may transmit, to the supporting UE, the first PRS sequence using the resources acquired for the first PRS sequence, receive, from the supporting UE, the second PRS sequence using the resources acquired by the supporting UE for the second PRS sequence, and transmit, to the supporting UE, the third PRS sequence using the resources acquired for the third PRS sequence.

In some instances, e.g., when the sidelink positioning procedure comprises a double sided RTT procedure, to acquire the resources, the UE may acquire resources for a first PRS. In addition, the UE may transmit, to the supporting UE, the first PRS sequence using the resources acquired for the first PRS sequence, receive, from the supporting UE, a second PRS sequence using resources acquired by the supporting UE for the second PRS sequence, acquire resources for a third PRS sequence transmission, and transmit, to the supporting UE, the third PRS sequence using the resources acquired for the third PRS sequence.

In some instances, to acquire the resources, the UE may acquire resources for at least a transmission of a first PRS sequence. In addition, the UE may communicate, to the supporting UE, the acquired resources for at least the first PRS sequence. In some instances, e.g., when the sidelink positioning procedure comprises a single sided RTT procedure, the UE may transmit, to the supporting UE, the first PRS sequence using the acquired resources and receive, from the supporting UE, a second PRS sequence using the acquired resources. In some instances, e.g., when the sidelink positioning procedure comprises a single sided RTT procedure, the UE may transmit, to the supporting UE, the first PRS sequence using the acquired resources and receive, from the supporting UE, a second PRS sequence using resources configured based on the acquired resources. The resources for the second PRS sequence may be semi-statically or dynamically configured relative the acquired resources for the first PRS sequence. In some instances, e.g., when the sidelink positioning procedure comprises a double sided RTT procedure, the UE may transmit, to the supporting UE, the first PRS sequence using the acquired resources, receive, from the supporting UE, a second PRS sequence using the acquired resources, and transmit, to the supporting UE, a third PRS sequence using the acquired resources. In some instances, e.g., when the sidelink positioning procedure comprises a double sided RTT procedure, the UE may transmit, to the supporting UE, the first PRS sequence using the acquired resources, receive, from the supporting UE, a second PRS sequence using resources configured based on the acquired resources, and transmit, to the supporting UE, a third PRS sequence using resources configured based on the acquired resources. The resources for the second PRS sequence and third PRS sequence may be semi-statically or dynamically configured relative the acquired resources for the first PRS sequence.

In some instances, to determine the resources for at least one RTT transmission as part of the sidelink positioning procedure, the UE may determine the resources based on a semi-static configuration receive via higher-layer signaling. The resources may be configured as periodic or semi-periodic transmissions. The higher-layer signaling may include at least one of radio resource control (RRC) signaling, Long Term Evolution (LTE) positioning protocol (LPP) signaling, sidelink LLP (SLPP) signaling, and/or PC5-RRC signaling.

In some instances, to determine the resources for at least one RTT transmission as part of the sidelink positioning procedure, the UE may randomly select resources within a specified range of a location request.

In some instances, to determine the resources for at least one RTT transmission as part of the sidelink positioning procedure, the UE may receive a plurality of configurations of resources for the at least one RTT transmission and randomly select resources from the plurality of configurations of resources. In some instances, the UE may communicate, to the supporting UE, the randomly selected resources.

In some instances, the UE may transmit, to a location management function (LMF), such as LMF 609, measurement results associated with the sidelink positioning procedure. The measurement results may include any of a physical cell ID (PCI), a group cell ID (GCI), a PRS identity (ID), an absolute radio-frequency channel number (ARFCN), a PRS resource ID, a PRS resource ID set for each measurement, SL UE IDs, sidelink PRS and/or SRS information for each measurement, sidelink PRS and/or SRS RSRP measurements, one or more UE Rx-Tx time difference measurements, a time stamp (X1) for a start of one or more sidelink RS transmissions, a UE Rx-Tx time difference for a measurement, i, a quality for each measurement, and/or a timing advance (TA) offset used by the UE.

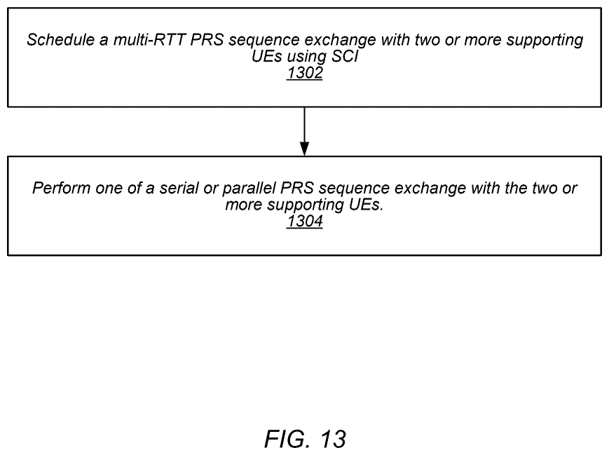

FIG. 13 illustrates a block diagram of an example of a method for multi-round trip time (RTT) estimation as part of a sidelink positioning procedure, according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1302, a UE, such as UE 106, may schedule a multi-RTT PRS sequence exchange with two or more supporting UEs using sidelink control information (SCI). The SCI may be the same as an SCI for a physical sidelink shared channel (PSSCH) or a dedicated SCI for RTT PRS sequence transmission. The dedicated SCI may be different than an SCI for a PSSCH.

At 1304, the UE may perform one of a serial or parallel PRS sequence exchange with the two or more supporting UEs.

In some instances, e.g., when the multi-RTT is single sided, the UE, for a serial PRS sequence exchange, may transmit, to a first supporting UE of the at least two supporting UEs, a first PRS sequence and receive, from the first supporting UE, a second PRS sequence. Additionally, the UE may transmit, to a second supporting UE of the at least two supporting UEs, a third PRS sequence and receive, from the second supporting UE, a fourth PRS sequence.

In some instances, e.g., when the multi-RTT is single sided, the UE may, for a parallel PRS sequence exchange, transmit, to a first supporting UE of the at least two supporting UEs, a first PRS sequence and transmit, to a second supporting UE of the at least two supporting UEs, a second PRS sequence. In addition, the UE may receive, from the first supporting UE, a third PRS sequence and receive, from the second supporting UE, a fourth PRS sequence.

In some instances, e.g., when the multi-RTT is double sided, the UE may, for a serial PRS sequence exchange, transmit, to a first supporting UE of the at least two supporting UEs, a first PRS sequence and receive, from the first supporting UE, a second PRS sequence. In addition, the UE may transmit, to the first supporting UE, a third PRS sequence and transmit, to a second supporting UE of the at least two supporting UEs, a fourth PRS sequence. Further, the UE may receive, from the second supporting UE, a fifth PRS sequence and transmit, to the second supporting UE, a sixth PRS sequence.

In some instances, e.g., when the multi-RTT is double sided, the UE may, for a parallel PRS sequence exchange, transmit, to a first supporting UE of the at least two supporting UEs, a first PRS sequence and transmit, to a second supporting UE of the at least two supporting UEs, a second PRS sequence. In addition, the UE may receive, from the first supporting UE, a third PRS sequence and receive, from the second supporting UE, a fourth PRS sequence. Further, the UE may transmit, to the first supporting UE, a fifth PRS sequence and transmit, to the second supporting UE, a sixth PRS sequence.

In some embodiments, the UE may transmit, to a location management function (LMF), such as LMF 609, measurement results associated with one of the serial or parallel PRS sequence exchange with the two or more supporting UEs. In some embodiments, the measurement results may include any of a physical cell ID (PCI), a group cell ID (GCI), a PRS identity (ID), an absolute radio-frequency channel number (ARFCN), a PRS resource ID, a PRS resource ID set for each measurement, SL UE IDs, sidelink PRS and/or SRS information for each measurement, sidelink PRS and/or SRS RSRP measurements, one or more UE Rx-Tx time difference measurements, a time stamp (X1) for a start of one or more sidelink RS transmissions, a UE Rx-Tx time difference for a measurement, i, a quality for each measurement, and/or a timing advance (TA) offset used by the UE.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for capability exchange for a sidelink positioning procedure, comprising:
a user equipment device (UE),
transmitting an indication of sidelink positioning capabilities including a round trip time (RTT) measurement capability and a positioning reference signal (PRS) capability;
determining a supporting UE for a sidelink positioning procedure based, at least in part, on sidelink positioning capabilities of the supporting UE; and
requesting a start of the sidelink positioning procedure.

2. The method of claim 1,
wherein the RTT measurement capability indicates whether the UE supports one or both of single sided RTT or double sided RTT.

3. The method claim 2,
wherein, when the UE supports double sided RRT, the indication of sidelink positioning capabilities further includes a feedback capability.

4. The method of claim 3,
wherein the feedback capability indicates one of explicit feedback or implicit feedback.

5. The method of claim 1,
wherein the PRS capability indicates support for one or more of:
a standalone PRS slot;
PRS slots multiplexed with physical sidelink shared channel (PSSCH) slots;
Zadoff Chu sequenced based PRS; or
Gold sequenced based PRS.

6. The method of claim 1,
wherein the indication of sidelink positioning capabilities is transmitted to the supporting UE.

7. The method of claim 6, further comprising:
the UE,
receiving, from the supporting UE, an indication of the supporting UE's sidelink positioning capabilities.

8. The method of claim 1,
wherein the indication of sidelink positioning capabilities is transmitted to a location management function (LMF).

9. The method of claim 8, further comprising:
the UE,
receiving, from the LMF, an indication of the supporting UE's sidelink positioning capabilities.

10.-20. (canceled)

21. An apparatus, comprising:
a memory; and
processing circuitry in communication with the memory and configured to:
transmit an indication of sidelink positioning capabilities including a round trip time (RTT) measurement capability and a positioning reference signal (PRS) capability;
determine a supporting user equipment device (UE) for a sidelink positioning procedure based, at least in part, on sidelink positioning capabilities of the supporting UE; and
request a start of the sidelink positioning procedure.

22. The apparatus of claim 21,
wherein the RTT measurement capability indicates whether one or both of single sided RTT or double sided RTT is supported.

23. The apparatus of claim 21,
wherein the indication of sidelink positioning capabilities is transmitted to a sidelink location management function (SL-LMF).

24. The apparatus of claim 23,
wherein the processing circuitry is further configured to:
receive, from the SL-LMF, an indication of the supporting UE's sidelink positioning capabilities.

25. The apparatus of claim 21,
wherein, to determine the supporting UE for the sidelink positioning procedure, the processing circuitry is further configured to select the supporting UE for absolute positioning in a multi-RTT positioning procedure.

26. The apparatus of claim 21,
wherein, to determine the supporting UE for the sidelink positioning procedure, the processing circuitry is further configured to select the supporting UE for an-RTT positioning procedure.

27. The apparatus of claim 21,
wherein, to determine the supporting UE for the sidelink positioning procedure, the processing circuitry is further configured to receive an indication from one of a location management function (LMF) or sidelink LMF (SL-LMF) indicating the supporting UE the sidelink positioning procedure.

28. A non-transitory computer readable memory medium storing instructions executable by processing circuitry to cause a user equipment device (UE) to:
transmit an indication of sidelink positioning capabilities including a round trip time (RTT) measurement capability and a positioning reference signal (PRS) capability;
determine a supporting user equipment device (UE) for a sidelink positioning procedure based, at least in part, on sidelink positioning capabilities of the supporting UE; and
request a start of the sidelink positioning procedure.

29. The non-transitory computer readable memory medium of claim 28,
wherein, to request the start of the sidelink positioning procedure, the instructions are further executable by the processing circuitry to cause the UE to transmit the request to the supporting UE.

30. The non-transitory computer readable memory medium of claim 28,
wherein, to request the start of the sidelink positioning procedure, the instructions are further executable by the processing circuitry to cause the UE to transmit the request to one of a location management function (LMF) or a sidelink LMF.

31. The non-transitory computer readable memory medium of claim 28,
wherein the instructions are further executable by the processing circuitry to cause the UE to:
receive, from one of a location management function (LMF) or a sidelink LMF, assistance data.
